(19) United States
(12) Patent Application Publication
(10) Pub. No.: US 2016/0322915 A1
(43) Pub. Date: Nov. 3, 2016

(54) Dual AC and DC Output Flyback Converter and Associated Systems and Methods

(71) Applicant: University of Connecticut, Farmington, CT (US)

(72) Inventors: Ali Bazzi, Vernon, CT (US); Julio Yela, Waterbury, CT (US); Luocheng Wang, Mansfield Center, CT (US)

(73) Assignee: University of Connecticut, Farmington, CT (US)

(21) Appl. No.: 15/140,153

(22) Filed: Apr. 27, 2016

Related U.S. Application Data
(60) Provisional application No. 62/153,579, filed on Apr. 28, 2015.

(51) Int. Cl. H02M 7/483; H02M 7/5395; H02M 3/335

(52) U.S. Cl. CPC H02M 7/483; H02M 3/33507; H02M 7/5395

(57) ABSTRACT

Exemplary embodiments of flyback converters are provided. The flyback converters include a voltage input, a flyback transformer including a primary winding circuitry, and first and second secondary winding circuitries. The flyback transformer can be electrically connected to the voltage input. The first and second secondary winding circuitries can be electrically connected to the flyback transformer. The first secondary winding circuitry can be a DC output circuit. The second secondary winding circuitry can be an AC output circuit. Exemplary embodiments of methods and systems of power conversion are also provided.

### CROSS-REFERENCE TO RELATED APPLICATION

The present application claims priority benefit to a provisional application entitled “Dual AC and DC Output Flyback Converter and Associated Systems and Methods,” which was filed on Apr. 28, 2015, and designated by Ser. No. 62/153,579. The entire content of the foregoing provisional patent application is incorporated herein by reference.

### TECHNICAL FIELD

The present invention generally relates to flyback converters and associated systems and methods and, in particular, to flyback converters with dual alternating current (AC) and direct current (DC) output.

### BACKGROUND

Traditional flyback converters are generally used for isolated power conversion and include a voltage input and a load output. Flyback converters generally include multiple secondary windings that can be used to construct multiple DC output ports. Some flyback converters can be used to support a DC load. Other flyback converters can be used to support an AC load.

Thus, rather than having the capability to support both DC and AC loads, the appropriate flyback converter must be used based on the desired output load at the output. Having multiple independent converters can be inefficient in a number of applications, e.g., in rural areas where both high voltage (for charging phones, batteries, light-emitting diode (LED) lighting, and the like) and high frequency (for fluorescent light) power applications are needed, in disaster or military zones, or the like.

Thus, a need exists for flyback converters that provide dual DC and AC output. These and other needs are addressed by the flyback converters and associated systems and methods of the present disclosure.

### SUMMARY

In accordance with embodiments of the present disclosure, exemplary flyback converters are provided. The flyback converters include a voltage input, a flyback transformer including a primary winding circuitry, and two secondary winding circuitries (e.g., first and second secondary winding circuitries). The flyback transformer can be electrically connected to the voltage input. The first secondary winding circuitry can be electrically connected to the flyback transformer. The second secondary winding circuitry can be electrically connected to the flyback transformer. The first secondary winding circuitry can be a direct current (DC) output circuit. The second secondary winding circuitry can be an alternating current (AC) output circuit.

The voltage input can be a direct current (DC) voltage input. The second secondary winding circuitry can include an inductor-capacitor low pass filter (LPF). The flyback converter can include a metal-oxide-semiconductor field-effect transistor (MOSFET) and/or other transistors electrically connected to the voltage input. The flyback converter can include a snubber circuit electrically connected across the primary winding circuitry of the flyback transformer. The snubber circuit can include a snubber capacitor, a snubber resistor, and an incoming duty signal.

A flyback turns ratio of the flyback transformer can be 1:N. The DC output circuit can include a rectifying diode, a capacitor, and a load (e.g., a resistor). The AC output circuit can include an inductor, a capacitor, and a load (e.g., a resistor). The first secondary winding circuitry can include a first secondary coil. The second secondary winding circuitry can include a second secondary coil. The flyback converter can include a gate driver and a pulse width modulator.

In accordance with embodiments of the present disclosure, exemplary systems for converting electrical power are provided that include a flyback converter as described herein. The systems can include a voltage input source providing the voltage input to the flyback converter.

In accordance with embodiments of the present disclosure, exemplary methods of converting electrical power are provided. The methods include receiving a voltage input at a flyback converter. The methods include converting the voltage input with the first secondary winding circuitry to a DC output voltage. The methods include converting the voltage input with the second secondary winding circuitry to an AC output voltage. The methods can include operating the flyback converter with a switching pulse.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed flyback converters and associated systems and methods, reference is made to the accompanying figures, wherein:

FIG. 1 is diagram of an exemplary flyback converter according to the present disclosure;

FIG. 2 is a top view of a prototype of an exemplary flyback converter according to the present disclosure;

FIG. 3 is a graph showing input voltage and current waveforms with Vᵢₙ=6.5V, R_{dc}=50.4Ω, and R_{ac}=31Ω for an exemplary flyback converter; and

FIG. 4 is a graph showing an AC output generation relative to a primary coil voltage with Vᵢₙ=6.5V, R_{dc}=50.4Ω, and R_{ac}=31Ω for an exemplary flyback converter.

### DESCRIPTION OF EXEMPLARY EMBODIMENTS

In accordance with embodiments of the present disclosure, exemplary flyback converters are provided that include a topology with dual DC and AC outputs. As will be discussed in greater detail below, the topology of the exemplary flyback converter elaborates the diversity of the DC and AC power forms in a single converter. In particular, the flyback converter takes advantage of one of the additional secondary windings of a flyback transformer to generate a continuous high-frequency AC output voltage, along with the conventional DC output voltage on a different output port, thereby providing a flyback converter for various applications.

The DC output can follow the substantially traditional configuration, while the AC output can be achieved by adding an inductor capacitor (L-C) LPF to an additional secondary winding. The dual output flyback converter integrates a standalone DC/DC converter with a DC/AC inverter, thereby saving space and switching devices, as well as improving the total energy conversion efficiency of the flyback converter, compared to conventional separated AC-DC, DC-DC and/or AC-DC-AC conversion. The AC output of the flyback converter can be used simultaneously to the DC output. Thus, rather than having only a DC output, both AC and DC outputs can be used simultaneously for a variety of applications. In some embodiments, the outputs can be correlated. In some embodiments, the range of the DC output and/or the AC output relative to the DC and/or AC input can vary depending on a turns ratio N of the transformer, the duty cycle of the MOSFET and/or transistor, or both.

The exemplary flyback converter offers various output power forms with enhanced power efficiency and low-cost electrical components in order to increase energy availability in daily use, eventually saving costs for the user. Specifically, it can be more economical to use a multi-winding flyback transformer even for a single-output application, as compared to traditional flyback converters, thereby adding the AC output port as an optional output with a minimal cost increase.

Flyback transformers used in single DC output flyback converters generally include more than one secondary output port. The flyback converters discussed herein can use one of the additional output ports as an AC output port at no extra cost (except the added filter), as compared to using a completely separate converter to generate the AC output. The flyback converter also provides AC and DC outputs that are electrically isolated from each other and from the input. Isolation of the AC and DC outputs can be critical in several applications and acts as a safety feature for the flyback converter.

The exemplary flyback converters can be used for a variety of applications, especially when both DC and AC power are necessary. However, it should be understood that the flyback converters can also be used for only DC or only AC output. For example, in rural, solar-powered, stand-alone systems, the flyback converter can be integrated with solar photovoltaics (PV) in rural energy systems providing energy to simple DC loads (such as batteries, phones, LED lighting, or the like), as well as high-frequency AC loads (such as fluorescent lights with a bypassed front end rectifier and high-frequency inverter). Thus, the flyback converters allow for distributed energy systems for rural areas along with conventional power supply.

Solar power systems may require inverters to convert the solar DC voltages to household AC outlets for use (e.g., 60 W). These are generally referred to as micro inverters since due to the small box size (as opposed to large transformers). The exemplary flyback converters can be used in these types of inverters, power converters, or the like. The flyback converters can also be used in, e.g., disaster zones, hospital applications, military applications, or the like, wherein both AC and DC power output is desired.

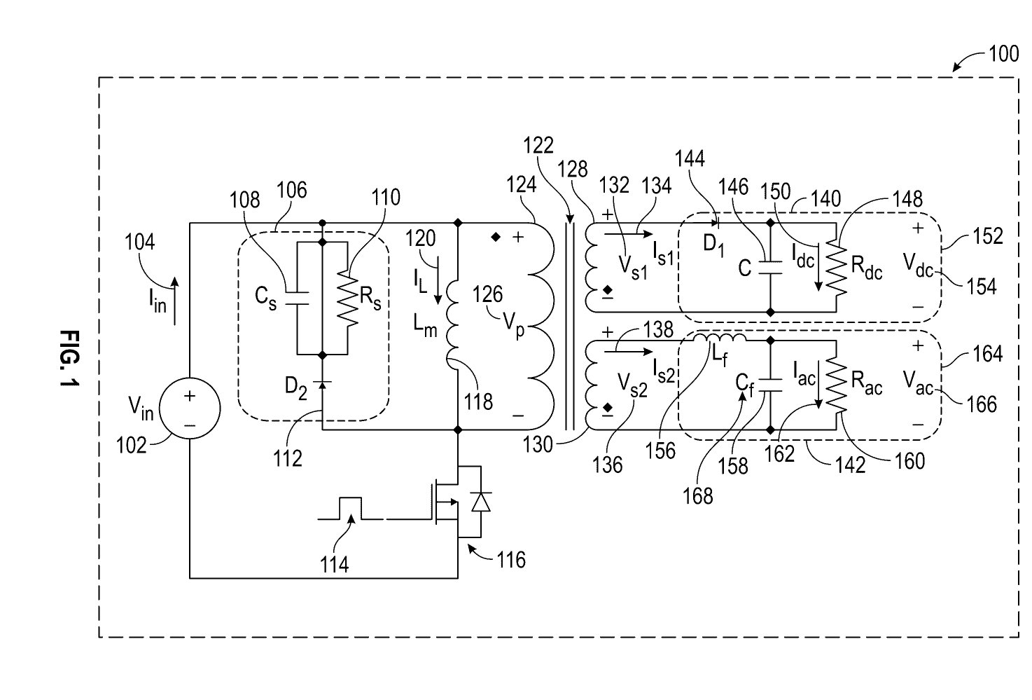

With reference to FIG. 1, a diagrammatic topology of an exemplary flyback converter 100 is provided. The converter 100 can be included within a system 101 for converting electrical power or energy. The system 101 can include a voltage input source 103 for providing voltage to the flyback converter 100. In particular, the converter 100 includes a DC voltage input 102 (Vᵢₙ) which provides an input current 104 (Iᵢₙ) to the converter 100. The converter 100 includes a snubber circuit 106 designated by the dashed lines. The snubber circuit 106 can include a snubber capacitor 108 (Cₛ), a snubber resistor 110 (Rₛ), and a snubber diode 112 (D₂). The converter 100 further includes a gate signal 114 (e.g., provided by a gate drive circuit) and a metal-oxide-semiconductor field-effect transistor (MOSFET) 116 (e.g., MOSFET Part No. IRF4332 manufactured by International Rectifier, El Segundo, Calif. USA) and/or another transistor. The converter 100 can include a transformer primary magnetizing inductor 118 (Lₘ) with an inductor current 120 (I_{L}) passing over the inductor 118.

The converter 100 includes a flyback transformer 122. The transformer 122 can have a 1:N flyback turns ratio. One side of the transformer 122 includes a primary coil 124 (e.g., a primary winding circuitry) with a voltage (Vₚ) 126. The opposing side of the transformer 122 includes a first secondary coil 128 and a second secondary coil 130 (e.g., first and second secondary winding circuitries). In some embodiments, the converter 100 can include multiple secondary coils. A voltage 132 (Vₛ₁) can pass over the first secondary coil 128 and includes a current 134 (Iₛ₁). A voltage 136 (Vₛ₂) can pass over the second secondary coil 130 and includes a current 138 (L₂).

The converter 100 includes a DC output circuit 140 associated with the first secondary coil 128 and an AC output circuit 142 associated with the second secondary coil 130. The DC output circuit 140 can include a rectifying diode 144 (D₁). The DC output circuit 140 further includes a capacitor 146 (C), a load resistor 148 (Rd_{dc}), and a current 150 (I_{dc}) passing over the load resistor 148. The DC output circuit 140 includes a DC output port 152 having a DC output voltage 154 (V_{dc}).

The AC output circuit 142 includes an inductor 156 (L_{f}), a capacitor 158 (C_{f}), a resistive load 160 (R_{ac}), and a current 162 (I_{ac}) passing over the resistive load 160. The inductor 156 and the capacitor 158 can form a low-pass filter (LPF) 168 of the AC output circuit 142. The AC output circuit 142 further includes an AC output port 164 having an AC output voltage (V_{ac}).

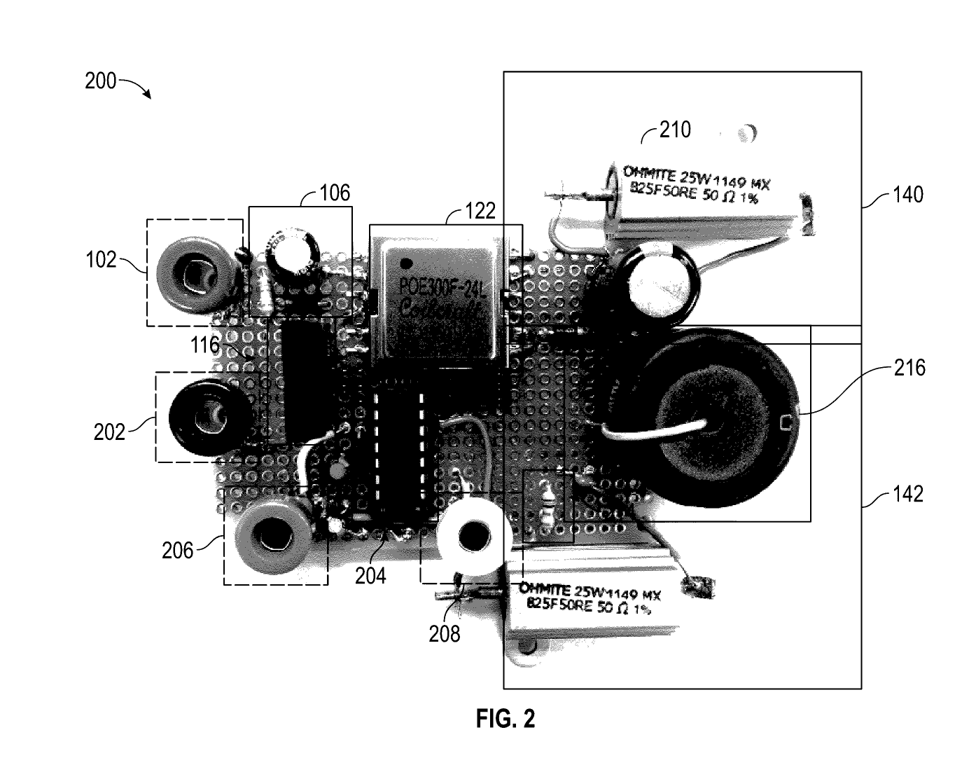

With reference to FIG. 2, an exemplary flyback converter 200 is provided. The converter 200 can be substantially similar in structure and function to the converter 100 discussed above, except for the distinctions noted herein. As such, the same reference numbers are used for components having the same functionality.

The converter 200 includes a voltage input 102, a ground 202, and a MOSFET 116. The converter 200 further includes a snubber circuit 106, a gate driver 204 for sending a gate signal, and a gate driver power source 206. The converter 200 can include a pulse width modulation (PWM) input 208 and a flyback transformer 122. The converter 200 includes a DC output circuit 140 with a load 210 and an AC output circuit 142 with a load 212. The AC output circuit 142 can include a sensing resistor 214 and an LPF (L_{f}, C_{f}) 216.

Although the topology discussed herein is in reference to the converter 100, it should be understood that the description also applies to the converter 200, except for any distinctions noted herein. As discussed above, the converter 100 of FIG. 1 includes a first secondary coil 128 as a DC output port 152 and uses one of the additional secondary coils 130 as an AC output port 164, thereby providing two types of voltage output in one converter 100. The AC output circuit 142 can conduct during all portions of a switching cycle from the primary side of the converter 100 (e.g., the primary coil 124) to output a substantially continuous sinusoidal wave. Since the coupled-inductor or transformer inherently blocks DC current from propagating to the second secondary coil 130 side, only an additional second-order resonant circuit (LC) low-pass filter 168 can be required on the second secondary coil 130 side to achieve a clean high-frequency AC output signal.

As shown in FIG. 1, the transformer primary magnetizing inductance (Lₘ) of inductor 118 can be connected to a DC voltage input 102 and can be followed by the switching MOSFET 116 at a high frequency. The snubber circuit 106 can reduce the ripple of the voltage input 102 and dissipates the remaining air gap energy after a switching cycle. In some embodiments, the DC output circuit 140 can be wired in a manner substantially similar to traditional converters.

The AC output port circuit 142 can include a second-order resonant circuit low-pass filter 168 to shape the voltage 136 from a zero-offset square wave to a substantially sinusoidal wave. The AC output voltage 166 can be substantially continuous since the voltage 136 is a substantially continuous square wave induced by the primary winding, e.g., coil 124, and MOSFET 116 switching. The AC terminal can provide a continuous output at the switching frequency. The real power transferred from the second secondary coil 130 to the load and the filter 168 can be ideally conserved since the filter 168 only contains an inductor 156 and a capacitor 158 that impact reactive power.

The exemplary prototype converter 200 of FIG. 2 is based on the topology of the converter 100 shown in FIG. 1. The converter 200 can be run under an open-loop control where the PWM 208 signal can be provided to the gate driver 204 without closed-loop feedback. As an exemplary setting, the snubber diode 112 can be set to approximately 50%, the switching frequency (f) can be set to approximately 100 kHz, and the flyback turns ratio (N) can be set to approximately 1:0.33 per output port. In some embodiments, the turns ratio can be set to a value between approximately 0.33 and approximately 1. Although discussed herein as 0.33, it should be understood that the turns ratio can be an alternative value.

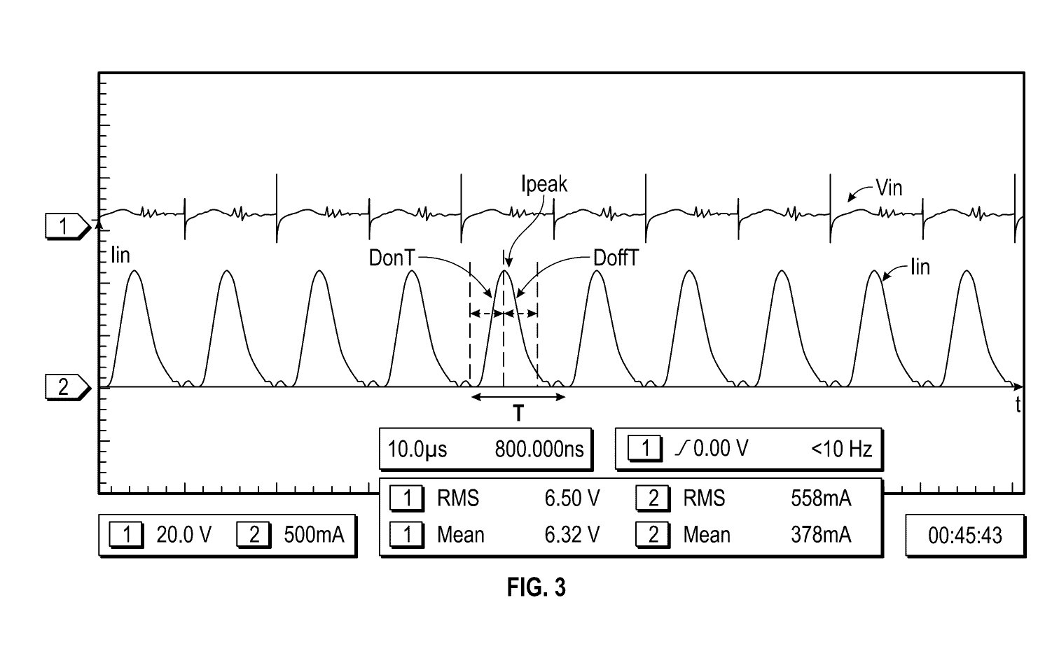

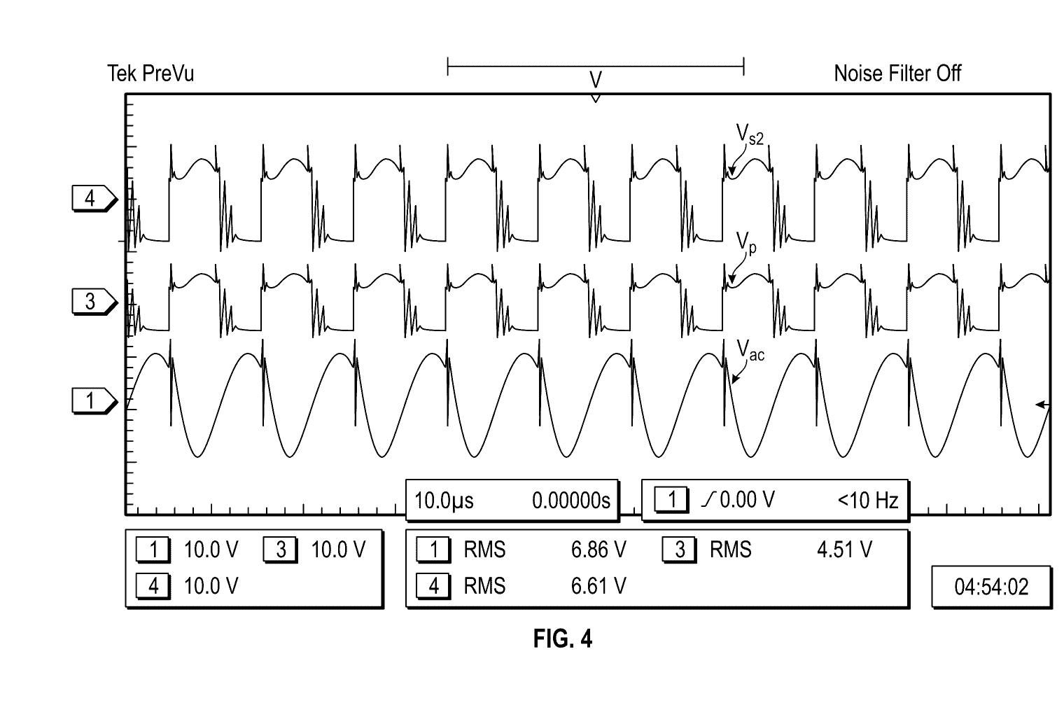

The converter 200 was constructed with minimum leads, wires, and a two-layer prototype board, thereby reducing board parasitic effects. The dual-output flyback converter 200 was tested in the discontinuous conduction mode (DCM). Various resistive loads were tested at both AC and DC output ports. The results from these tests under various input voltages with open-loop control were recorded and are shown in FIGS. 3 and 4. In particular, FIG. 3 shows the input voltage and current waveforms with input voltage Vᵢₙ=6.5V and DC and AC resistance values of R_{dc}=50.4Ω and R_{ac}=31ω. FIG. 4 shows DC and AC output waveforms with input voltage Vᵢₙ=6.5V and DC and AC resistance values of R_{dc}=50.4Ω and R_{ac}=31Ω. Efficiency was calculated by assuming that the total input power was conserved as losses plus the power delivered to the DC and AC loads. In an idea situation, without any other dissipation or heat, the energy in the dual output flyback converter 100, 200 would be conserved.

With reference to FIG. 3, the input voltage and current waveforms are shown. The DC input voltage (Vᵢₙ) is slightly distorted by the switching signal. The DC input current (Iᵢₙ) shows that the current increases during every switching cycle of “ON” and returns to approximately zero before every single end of the switching cycle. In particular, T represents one time period, DₒₙT represents the duty ratio of the MOSFET switching signal during the switching cycle of “ON”, and D_{off}T represents the portion of the period during which the input current (Iᵢₙ) decays from the peak current (Iₚₑₐₖ) to approximately zero. However, comparing the dual-output to a single-output flyback converter, the duty ratio (D) can be affected and reduced from approximately 50% as set on the pulse width modulator source to approximately 35% (Dₒₙ) in the hardware testing. The converter takes approximately 25% of one period for the input current to return to approximately zero (D_{off}), and the remaining zero-current portion of the switching period is approximately 40%.

With reference to FIG. 4, an example of AC output generation is provided relative to a primary coil voltage (vₚ). In particular, FIG. 4 shows the second secondary voltage (vₛ₂), the AC voltage (v_{ac}) at the AC output port circuit and which represents the output of LPF being fed by the second secondary voltage, and the primary coil voltage (vₚ). The AC voltage is substantially continuous and stable. Thus, the AC output port can function as expected for the proposed dual-output flyback converter.

Various inputs with the converter load combination were tested, i.e., where the DC and AC resistance value R_{dc}=50.4Ω and R_{ac}=31Ω. The results for the experimentation is shown below in Table 1.

TABLE 1
Various Input Voltages For R_{dc} = 50.4 Ω, R_{ac} = 31 Ω

| Input Stage | | | DC Output | | AC Output | | Output | |
|---|---|---|---|---|---|---|---|---|
| Vᵢₙ | Iᵢₙ | Pᵢₙ | V_{dc} | I_{dc} | V_{ac} | I_{ac} | Power | η |
| (V) | (A) | (W) | (V) | (A) | (V) | (A) | (W) | (%) |
| 6.50 | 0.35 | 2.275 | 5.00 | 0.107 | 6.97 | 0.227 | 2.14 | 94.1 |
| 8.50 | 0.40 | 3.40 | 6.25 | 0.127 | 8.70 | 0.277 | 3.20 | 94.1 |
| 10.5 | 0.44 | 4.62 | 7.60 | 0.154 | 10.3 | 0.326 | 4.52 | 97.8 |
| 12.5 | 0.48 | 6.00 | 8.69 | 0.164 | 11.8 | 0.376 | 5.86 | 97.6 |

Modeling assists in understanding the proposed topology including interaction between the input and output, and between the DC and AC output ports. Only an ideal converter is considered and compared to the non-ideal experimentation results provided. It can be assumed that both the DC and AC output powers are completely dissipated in the resistive loads where other resistive elements, e.g., capacitor ESR, or the like, are ignored. The snubber circuit can be neglected since under ideal conditions, all energy stored in the flyback transformer air gap would be released to the dual-output ports in the discontinuous conduction mode.

Through the average input voltage and current waveforms in FIG. 3 and approximating the current non-zero portion as a triangle, the average input energy into the flyback converter can be represented by Equation 1:

$${E}_{in} = \frac{1}{2} {V}_{in} ( {I}_{peak} + {I}_{o} ) ( {D}_{on} + {D}_{off} ) T \qquad ( 1 )$$

where Iₚₑₐₖ represents the peak value of the input current (e.g., the current value at the end of every switching “ON” period) and I₀ represented the returning input current value at the end of every switching cycle. Since the flyback converter topology is operated in discontinuous conduction mode, the input current returns to approximately zero before the end of a switching cycle and, thus, I₀ is always approximately zero. T represents one period time of a switching cycle (e.g., T=1/f). Dₒₙ represents the duty ratio of the MOSFET switching signal where the input current Iᵢₙ increases to the peak current Iₚₑₐₖ during DₒₙT, and D_{off} represents the portion of T during which the input current Iᵢₙ decays from the peak current Iₚₑₐₖ to approximately zero. Equation 1 can therefore be rewritten as Equation 2:

$${E}_{in} = \frac{1}{2} {V}_{in} ( \frac{{V}_{in}}{{L}_{m}} {D}_{on} T ) ( {D}_{on} + {D}_{off} ) T \qquad ( 2 )$$

For modeling purposes, the sum of the DC and AC output port energy can be assumed to be equal to the input energy value because of energy conservation and assuming an ideal converter. Thus, the total output energy can be represented by Equation 3:

$$\frac{{V}_{in}^{2}}{2 {L}_{m}} {D}_{on} ( {D}_{on} + {D}_{off} ) T = \frac{{V}_{ac}^{2}}{{R}_{ac}} + \frac{{V}_{dc}^{2}}{{R}_{dc}} \qquad ( 3 )$$

The LC low-pass filter can alter the continuous square wave at the transformer second secondary winding into a sinusoidal wave with zero-offset at the AC output port. In particular, the LC low-pass filter blocks high frequency components and keeps the fundamental component in the Fourier series of the square wave. With the Fourier series, the square wave can be represented by Equation 4:

$${V}_{ac} ( t ) = A \frac{4}{π} {V}_{in} sin ( 2 π ft ) \qquad ( 4 )$$

Replacing V_{ac} in Equation 4 with Equation 3 and rearranging the terms yields V_{dc} as shown in Equation 5:

$${V}_{dc} = {V}_{in} \sqrt{( \frac{{D}_{on} ( {D}_{on} + {D}_{off} ) T}{2 {L}_{m}} ) {R}_{dc} - ( \frac{{A}^{2} 8}{{R}_{ac} {π}^{2}} ) {R}_{dc}} \qquad ( 5 )$$

Thus, as described herein, the exemplary flyback converters offer a topology with dual DC and AC outputs, thereby providing a flyback converter for various applications and improving the efficiency of traditional flyback converters.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

### REFERENCES

1. Siyang Zhao, Junming Zhang, and Yang Shi, “A low cost low power Flyback converter with a simple transformer,” in Proc. International Power Electronics and Motion Control Conference (IPEMC), 2012, pp. 1336-1342, 2012.
2. Xiangjun Zhang, Hankui Liu, and Z. Xu, “Analysis and design of the flyback transformer,” in Proc. Annual Conference of the IEEE Industrial Electronics Society (IECON), 2003, pp. 715-719.
3. N. Vazquez, H. Lopez, C. Hernandez, and H. Calleja, “Multiple-output DC-to-DC based on the flyback converter,” in Proc. IEEE International Power Electronics Congress, 2008, pp. 105-108.
4. C. K. Huang, H. H. Nien, S. K. Changchien, C. H. Chan, and C. K. Chen, “An optimal designed RCD snubber for DC-DC converters,” in Proc. International Conference on Control, Automation, Robotics and Vision, 2008, pp. 2202-2207.
5. W. McMurray, “Selection of Snubbers and Clamps to Optimize the Design of Transistor Switching Converters,” in IEEE Transactions on Industry Applications, vol. IA-16, no. 4, pp. 513-523, July 1980.
6. G. N. Wooding and A. S. De Beer, “The effect of leakage inductance and snubbing on electromagnetic interference generated by a flyback converter,” in Proc. AFRICON, 2011, pp. 1-5.
7. L. M. K. Johny, and T. K. J. Sebastian, “A flyback DCM DC-AC converter for PV applications,” in Proc. Annual International Conference on Emerging Research Areas and 2013 International Conference on Microelectronics, Communications and Renewable Energy, 2013, pp. 1-6.
8. S. Howimanporn, and C. Bunlaksananusorn, “Performance comparison of continuous conduction mode (CCM) and discontinuous conduction mode (DCM) flyback converters,” in Proc. International Conference on Power Electronics and Drive Systems (PEDS), 2003, pp. 1434-1438.
9. U.S. Pat. No. 4,302,803, Rectifier-converter power supply with multi-channel flyback inverter, Nov. 24, 1981.
10. U.S. Pat. No. 5,508,903, Interleaved DC to DC flyback converters with reduced current and voltage stresses, Apr. 16, 1996.
11. U.S. Pat. No. 6,078,509, Multiple output flyback converter having improved cross-regulation and method of operation thereof, Jun. 20, 2000.
12. U.S. Pat. No. 6,703,796, Power supply and inverter used therefor, Mar. 9, 2004.
13. U.S. Pat. No. 7,259,476, DC and AC uninterruptible power supply, Aug. 21, 2007.
14. U.S. Pat. No. 7,872,881, Secondary regulation in a multiple output flyback topology, Jan. 18, 2011.
15. U.S. Pat. No. 8,310,846, Single secondary rectification multi-outputs flyback converter adapted to minimize the number of components, Nov. 13, 2012.
16. International Patent Publication No. WO 2013004110, Solar photovoltaic grid-connected interleaved parallel flyback inverter, Jan 10, 2013.

1. A flyback converter, comprising:
a voltage input;
a flyback transformer electrically connected to the voltage input, the flyback transformer including a primary winding circuitry; and
first and second secondary winding circuitries electrically connected to the flyback transformer;
wherein the first secondary winding circuitry is a direct current (DC) output circuit; and
wherein the second secondary winding circuitry is an alternating current (AC) output circuit.

2. The flyback converter according to claim 1, wherein the voltage input is a direct current (DC) voltage input.

3. The flyback converter according to claim 1, wherein the second secondary winding circuitry comprises an inductor-capacitor low pass filter.

4. The flyback converter according to claim 1, comprising a metal-oxide-semiconductor field-effect transistor (MOSFET) electrically connected to the voltage input.

5. The flyback converter according to claim 1, comprising a snubber circuit electrically connected across the primary winding circuitry of the flyback transformer.

6. The flyback converter according to claim 5, wherein the snubber circuit comprises a snubber capacitor, a snubber resistor, and an incoming duty signal.

7. The flyback converter according to claim 1, wherein a flyback turns ratio of the flyback transformer is 1:N.

8. The flyback converter according to claim 1, wherein the direct current (DC) output circuit comprises a rectifying diode, a capacitor, and a load.

9. The flyback converter according to claim 1, wherein the alternating current (AC) output circuit comprises an inductor, a capacitor, and a load.

10. The flyback converter according to claim 1, wherein the first secondary winding circuitry comprises a coil.

11. The flyback converter according to claim 1, wherein the second secondary winding circuitry comprises a coil.

12. The flyback converter according to claim 1, comprising a gate driver.

13. The flyback converter according to claim 1, comprising a pulse width modulator.

14. A system for converting electrical power, the system comprising:
a flyback converter, the flyback converter including (i) a voltage input, (ii) a flyback transformer electrically connected to the voltage input, the flyback transformer including a primary winding circuitry, and (iii) first and second secondary winding circuitries electrically connected to the flyback transformer, the first secondary winding circuitry being a direct current (DC) output circuit, and the second secondary winding circuitry being an alternating current (AC) output circuit; and
a voltage input source providing the voltage input to the flyback converter.

15. The system according to claim 14, wherein the voltage input is a direct current (DC) voltage input.

16. The system according to claim 14, wherein the second secondary winding circuitry comprises as inductor capacitor low pass filter.

17. The system according to claim 14, comprising a metal-oxide-semiconductor field-effect transistor (MOSFET) electrically connected to the voltage input.

18. The system according to claim 14, comprising a snubber circuit electrically connected across the primary winding circuitry of the flyback transformer.

19. A method of converting electrical power, the method comprising:
receiving a voltage input at a flyback converter, the flyback converter including (i) a flyback transformer including a primary winding circuit, and (ii) first and second secondary winding circuitries;
converting the voltage input with the first secondary winding circuitry to a direct current (DC) output voltage; and
converting the voltage input with the second secondary winding circuitry to an alternating current (AC) output voltage.

20. The method according to claim 19, comprising operating the flyback converter with a switching pulse.
